(19) United States
(12) Patent Application Publication
(10) Pub. No.: US 2014/0161302 A1
(43) Pub. Date: Jun. 12, 2014

(54) ELECTRONIC DEVICE HAVING BUILT-IN EARPHONE

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: YAN XU, Shenzhen (CN); HUI YIN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/873,239

(22) Filed: Apr. 30, 2013

(30) Foreign Application Priority Data
Dec. 6, 2012 (CN) 2012105177371

(51) Int. Cl. H04R 1/00

(52) U.S. Cl. CPC H04R 1/00
USPC 381/387

(57) ABSTRACT

An electronic device includes an earphone driving unit, a loudspeaker driving unit, a first switch, an audio playing unit, a second switch, a detecting unit, and a processing unit. The second switch is turned on when the audio playing unit is received in a housing or turned off when the audio playing unit is taken out from the housing. The detecting unit generates a detecting signal associated with the operational state of the second switch. The processing unit controls the first switch to connect the earphone driving unit or the loudspeaker driving unit to the processing unit according to the detecting signal. In addition, transmits audio signal to the earphone driving unit or the loudspeaker driving unit, triggering the earphone driving unit or the loudspeaker driving unit to drive the audio playing unit to play the audio signal with an adjusted playing power.

### BACKGROUND

1. Technical Field

The present disclosure relates to electronic device, and particularly relates to an electronic device having built-in earphone.

2. Description of the Related Art

Commonly, electronic devices include earphone jacks for receiving a earphone when users privately listens audio files. The users must take out the earphone from the earphone jack when he or she wants to listen audio files with loudspeaker of the electronic device, which results in inconvenience for the users.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagram block of an electronic device, according to an exemplary embodiment.

FIG. 2 is a hardware diagram block of the electronic device with an audio playing unit being received therein.

FIG. 3 is a hardware diagram block of the electronic device with the audio playing unit being taken out.

### DETAILED DESCRIPTION

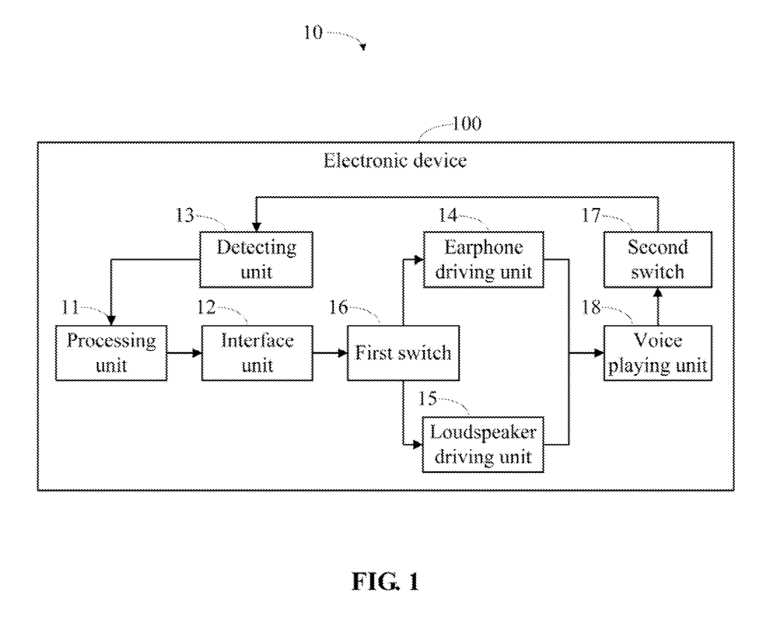

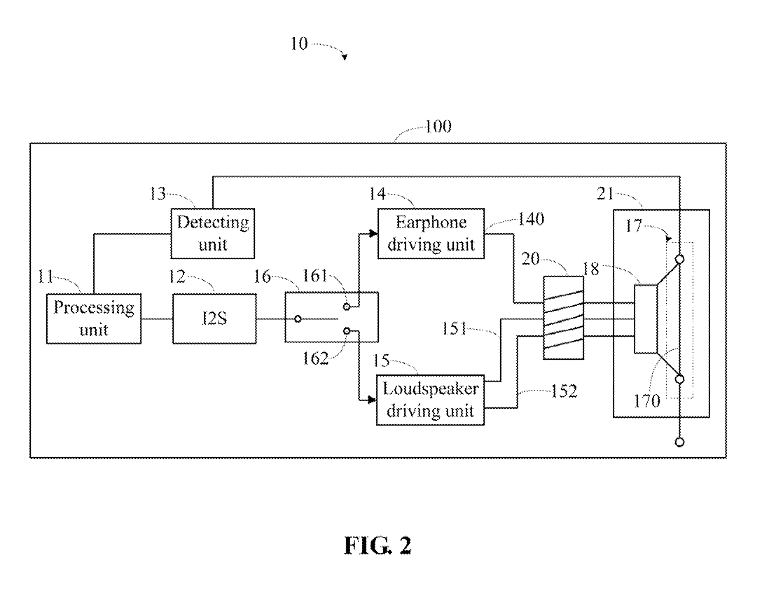

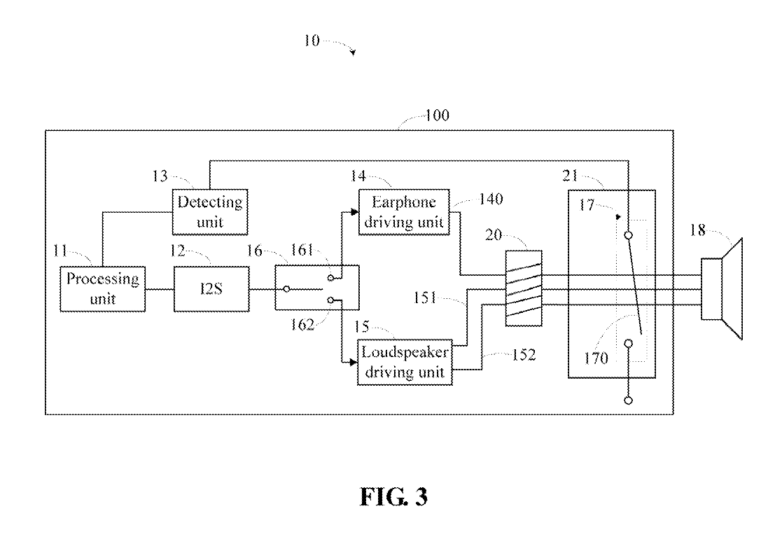

FIG. 1 is an embodiment of an electronic device 10 integrating an earphone with a loudspeaker. The electronic device 10 includes, a processing unit 11, an interface unit 12, a detecting unit 13, an earphone driving unit 14, a loudspeaker driving unit 15, a first switch 16, a second switch 17, and an audio playing unit 18. The audio playing unit 18 can be received in a housing 100 of the electronic device 10 or may be taken out from the housing 100 according to user's operation. The housing 100 of the electronic device 10 defines a receiving groove 21 (shown in FIGS. 2-3) for receiving the audio playing unit 18.

The second switch 17 is connected between the audio playing unit 18 and the detecting unit 13. The processing unit 11 is connected to the first switch unit 16 via the interface unit 12. The second switch 17 is turned on when the audio playing unit 18 is received in the housing 100 of the electronic device 10, and turned off when the audio playing unit 18 is taken out from the housing 100. The detecting unit 13 determines whether the audio playing unit 18 is received in the housing 100 or not according to whether the second switch 17 is turned on or off, and generates a detecting signal correspondingly. The processing unit 11 generates a switch control signal in response to the detecting signal generated by the detecting unit 13, transmits the switch control signal to the first switch 16 via the interface unit 12. The first switch 16 is switched to a first connecting path or a second connecting path in response to the switch control signal generated by the processing unit 11. The first connecting path is from the processing unit 11 to the earphone driving unit 14 via the first switch 16, and the second connecting path is from the processing unit 11 to the loudspeaker driving unit 15 via the first switch 16. The processing unit 11 transmits audio signal to the earphone driving unit 14 via the first connecting path or to the loudspeaker driving unit 15 via the second connecting path.

When the earphone driving unit 14 receives the audio signal transmitted from the processing unit 11, the earphone driving unit 14 adjusts a power of the audio signal to a relatively lower level to match a earphone, and drives the audio playing unit 18 to play the audio signal in the relatively lower level power. When the loudspeaker driving unit 18 receives the audio signal transmitted from the processing unit 11, the loudspeaker driving unit 18 adjusts a power of the audio signal to a relatively higher level that matches a loudspeaker, and drives the audio playing unit 18 to play the audio signal in the relatively higher power. In the embodiment, the audio playing unit 18 is a earphone, which is connected to the second switch 17 via cord.

FIGS. 2 and 3 show that the first switch 16 is a path switch such as a single pole dual throw switch, and the second switch 17 is a single pole single throw switch. The electronic device 10 further includes a reel 20, which is mounted in the electronic device 10. The reel is configured to feed the cord when the audio playing unit 18 is moved from the built-in position to the extended position. The second switch 17 is positioned adjacent to the receiving groove 21. When the audio playing unit 18 is received in the receiving groove 21, the cord is retracted and wound on the reel 20. A switch terminal 170 of the second switch 17 is pressed down by the audio playing unit 18, which results in the second switch 17 being turned on. When the audio playing unit 18 is taken out from the housing 100, the cord is unwound and extended from the reel 20, the switch terminal 170 is released which results in the second switch 17 is turned off.

In the embodiment, the interface unit 12 is an I2S interface unit.

When the audio playing unit 18 is received in the housing 100 of the electronic device 10, the second switch 17 is triggered to be closed by the audio playing unit 18 which results in the second switch 17 being turned on. The detecting unit 13 generates a first detecting signal when detects the second switch 17 is turned on. The processing unit 11 generates a first switch control signal in response to the first detecting unit, and transmits the first switch control signal to the first switch 16 via the interface unit 12. A switch terminal of the first switch 16 is switched to connect the loudspeaker driving unit 15 in response to the first switch control signal, which results in connecting the processing unit 11 to the loudspeaker driving unit 15 via the first switch 16. Then, the processing unit 11 transmits the audio signal via cord 151 and 152 to the loudspeaker driving unit 15. The loudspeaker driving unit 15 drives the audio playing unit 18 to play the audio signal in the adjusted power, thereby the audio playing unit 18 plays audio signal as a loudspeaker when the audio playing unit 18 is received in the housing 100.

When the audio playing unit 18 is taken out from the housing 100 of the electronic device 10, the second switch 17 is released to be opened by the audio playing unit 18 which results in the second switch 17 being turned off. The detecting unit 13 generates a second detecting signal when detecting the second switch 17 is turned off. The processing unit 11 generates a second switch control signal in response to the second detecting unit, and transmits the second switch control signal to the first switch 16 via the interface unit 12. The switch terminal of the first switch 16 is switched to connect the earphone driving unit 14 in response to the second switch control signal, which results in connecting the processing unit 11 to the earphone driving unit 14 via the first switch 16. Then, the processing unit 11 transmits the audio signal via a wire 140 to the earphone driving unit 14. The earphone driving unit 14 drives the audio playing unit 18 to play the audio signal in the adjusted power, thereby the audio playing unit 18 plays audio signal as a earphone when the audio playing unit 18 is taken out from the housing 100.

It is understood that the present disclosure may be embodied in other forms without departing from the spirit thereof. The present examples and embodiments are to be considered in all respects as illustrative and not restrictive, and the disclosure is not to be limited to the details given herein.

What is claimed is:

1. An electronic device comprising:
a housing;
an earphone driving unit;
a loudspeaker driving unit;
a first switch;
an audio playing unit connected to the earphone driving unit and the loudspeaker driving unit, the audio playing unit being movable between a built-in position where the audio playing unit is entirely received in the housing for functioning as a built-in loudspeaker, and an extended position wherein the audio playing unit is taken out from the housing for functioning as an earphone;
a second switch configured to selectively operate at a turn on state when the audio playing unit is received in the housing or a turn off state when the audio playing unit is taken out from the housing;
a detecting unit configured to determine whether the audio playing unit is received in the housing or not according to the operational state of the second switch, and generate a detecting signal associated therewith; and
a processing unit connected to the first switch, configured to generate a switch control signal according to the detecting signal generated by the detecting unit, transmit the switch control signal to the first switch to selectively connect the earphone driving unit or the loudspeaker driving unit to the processing unit, and further configured to transmit audio signal to the earphone driving unit or the loudspeaker driving unit via the first switch, triggering the earphone driving unit or the loudspeaker driving unit to drive the audio playing unit to play the audio signal with an adjusted playing power.

2. The electronic device as recited in claim 1, further comprising a reel, wherein the audio playing unit includes a cord configured to be wound around the reel, the reel is mounted within the housing, and configured to feed the cord when the audio playing unit is moved from the built-in position to the extended position.

3. The electronic device as recited in claim 2, wherein when the audio playing unit is received in the housing, the cord is retracted and wound on the reel the second switch is turned on, and the processing unit transmits a first switch control signal to the first switch to connect the loudspeaker driving unit to the processing unit; and when the audio playing unit is taken out from the housing, the cord is unwound and extended from the reel, the second switch is turned off, and the processing unit transmits a second switch control signal to the first switch to connect to the earphone driving unit to the processing unit.

4. The electronic device as recited in claim 3, wherein the housing defines a receiving groove for receiving the audio playing unit.

5. The electronic device as recited in claim 4, wherein the second switch is positioned adjacent to the receiving groove, a switch terminal of the second switch is pressed down by the audio playing unit when the audio playing unit is received in the receiving groove which causes the second switch to be turned on, and the switch terminal is released when the audio playing unit is taken out from the housing which causes the second switch to be turned off.
